(19) United States
(12) Patent Application Publication
(10) Pub. No.: US 2006/0196055 A1
(43) Pub. Date: Sep. 7, 2006

(54) Self clearing grilling fork

(76) Inventor: Roberto P. Barcala, Pembroke Pines, FL (US)

Correspondence Address: c/o JOHN H. FARO;FARO & ASSOCIATES, LLC, UNIT 201, 23751 MERANO COURT, BONITA SPRINGS, FL, 34134, US

(21) Appl. No.: 11/362,394

(22) Filed: Feb. 24, 2006

Related U.S. Application Data
(63) Continuation-in-part of application No. 10/707,899, filed on Jan. 22, 2004, now abandoned.
(60) Provisional application No. 60/319,900, filed on Jan. 24, 2003.

(51) Int. Cl. B25F 3/00

(52) U.S. Cl. 30/129

(57) ABSTRACT

A self-clearing grilling fork is provided wherein the a reciprocating clearing plate associated with tines of a grilling fork. This reciprocating clearing plate is activated by a spring loaded trigger mechanism in the pistol grip handle of the fork. The displacement of the trigger causes a rod, within the hollow tubular shaft of the fork, causes linear movement of the clearing plate relative to the tines on the end of the fork and thus displaces food and food residues from the tines on the end of the fork. In the preferred embodiments of this grilling fork a seal is provided within the hollow tubular shaft of the grilling fork to both facilitate relative movement of the rod with this shaft, and to otherwise seal the opening in the shaft to prevent food and debris associated with the cooking environment for entering into the shaft.

### CROSS REFERENCE TO RELATED APPLICATIONS

This application is a continuation-in-part of Utility application Ser. No. 10/707,899, filed Jan. 22, 2004, which is based upon prior filed Provisional Application Ser. No. 60/319,900, filed Jan. 24, 2004.

### BACKGROUND OF THE INVENTION

1. Field of the Invention

The present invention relates to a device and to a method. More specifically, this invention is directed to a barbeque or grilling fork, and to a method for the displacement (clearing) of food from the tines on the end of this fork without additional implements, or manual intervention.

2. Description of the Prior Art

The use of barbecuing or grilling implements/utensils to place, rearrange and/or remove food from upon the grilling surface of a barbecue grill is a well known.

Over the years, a number of such cooking utensils have been designed specifically for this purpose. Each of these utensils have been unique in their design, operation and function. With regard to the grilling fork, the food is generally manipulated on a barbecue grill, with such fork, by insertion of tines on the end of the fork into the food, so as to permit lifting of the cooked food off of the grilling surface. Because such tines do not readily release the food, and such cooked food is hot, a second implement must be used to remove the cooked food from the tines on the end of the grilling fork. This displacement of the food from the tines of the grilling fork, thus, requires that the cook use two hands—one to hold the folk and another to pry the food off the fork with another utensil.

In the process of rearranging, or flipping the food, such food must be displaced from the grilling fork while it is held over the cooking surface of the grill. Such operation subjects the cook to possible burns from splattering grease, or flare-ups from grease which ignites when it contacts the hot grilling surface of the barbecue, or coals within the barbecue.

In order to overcome this potential for injury to the cook, a number of grilling utensils of varying designs have been developed. A number of these designs permit the manipulation of the food over the grilling surface with one hand, thereby reducing the risks to cook of burns from splattering grease, and from flare-ups from igniting grease. Representative grilling utensils purportedly suitable for this purpose are disclosed in U.S. Pat. No. 4,844,525 (to Tarlow, issued Jul. 4, 1989) and U.S. Pat. No. 3,162,474 (to Allen, issued May, 6, 1961).

The Tarlow '525 patent discloses a combined spatula and grilling fork utensil in which an articulating member is positioned above the tines of the fork and activated by a trigger in the pistol grip handle of the utensil. Thus, when the utensil is used to rearranged the food on the grill, (e.g. as in a spatula mode), the tines of the fork are placed under the food, and the articulating member positioned above the food on the tines. Thereafter, the articulating member is activated by the trigger on the pistol grip handle. The articulating member, thus, grasps the food on the tines of the fork, so as to permit its removal and rearrangement on the surface of the grill. The subsequent release of the trigger of the pistol grip handle, causes retraction of the articulating member, and thereby the release of food from the end of the grilling fork. The Tarlow device, thus, eliminates one of the disadvantages in the use of the grilling fork, namely, the need for a separate utensil to displace food from the tines of the fork.

The Allen '474 patent discloses a food handling implement having a hook on the end thereof. This hook is positioned at right angles to the shaft of the implement. The Allen device is used to handle food, specifically, to lift and rearrange food on the surface of a barbecue grill. More specifically, the Allen implement can be used to pierce and lift food on the hook on the end of the utensil shaft. Conversely, the implement can be rotated along the axis of the shaft, and thereby disengage the food from the hook on the end of the shaft. Thus, the Allen device permits displacement of food from the end of his device without use of an additional utensil or manual intervention.

In each of the foregoing devices, the tines on the end of the grilling fork can become covered with grease and food residues, thereby causing food to stick to the end of the fork, notwithstanding the efforts made to prevent this from happening. Thus, the fork must be periodically cleaned to remove grease and food residues during normal use to retain its functionality; and, alternatively, another fork placed in service to avoid the problems associated with retained grease and food residues on the tines of the grilling fork.

Accordingly, there continues to exist a need to provide a grilling fork having both the traditional functions of the fork, while retaining such functions during continuous use. In practice such device must also be both simple to manufacture, operate and clean. Moreover, such device, to be practical, must also isolate its moving parts from contamination by food products and extraneous debris associated with a cooking environment.

### OBJECTS OF THE INVENTION

It is the object of this invention to remedy the above, as well as related deficiencies, in the prior art.

More specifically, it is the principle object of this invention to provide a self-clearing grilling fork which both preserves traditional fork design and function, and yet permits clearing of food from the tines of the fork without use of a separate implement or manual intervention.

It is another object of this invention to provide a self-clearing grilling fork in which a reciprocating member is associated with the tines of the fork, for removal of grease and food residues from the tines of the fork, with one hand.

It is yet another object of this invention to provide a self-clearing grilling fork in which the reciprocating member is activated by a trigger mechanism in the pistol grip handle of the fork, so as to clear food residues from the tines of the fork, without exposure of the cook's hands to the hazards associated with the elevated grilling temperature and grease flare-ups of the grilling environment.

Additional objects of this invention include a method for clearing food residues from the tines of a grilling fork.

### SUMMARY OF THE INVENTION

The above and related objects are achieved by providing a self-clearing grilling fork having a reciprocating clearing plate integral with the tines of the fork. This reciprocating plate has a series of apertures corresponding in diameter and position, to the cross-sectional area, and arrangement, of the tines on the end of the fork. In practice, this reciprocating clearing plate is fitted on the end of the fork, with the tines of the fork being placed through each aperture of the plate, corresponding to the position of each tine on the end of the fork. The back of this reciprocating clearing plate is contiguous with a fixed hollow tubular shaft, and a reciprocating solid shaft, of the fork. The reciprocating solid shaft is positioned within the fixed hollow tubular shaft of the fork, and attached, on one end thereof, to back of the reciprocating clearing plate. The other end of this reciprocating solid shaft is attached to a trigger mechanism, which is positioned within the pistol grip handle of the fork. In practice, the trigger mechanism is activated, in the conventional manner, by depressing the trigger, so as to cause linear movement of the solid shaft and reciprocating clearing plate. This linear movement of the solid shaft and reciprocating clearing plate, advances this clearing plate forward along the tines of the fork, and thereby displaces food and food and residues that may be present on the tines. Insofar as this triggering mechanism is spring loaded, the release of the trigger mechanism causes retraction of the solid shaft and reciprocating clearing plate from the tines. Thus, the tines of the fork remain essentially free of food and food residues which can cause sticking of the food to the fork in the course of continuous use thereof.

### BRIEF DESCRIPTION OF DRAWINGS

FIG. 1 is side view of the self-cleaning grilling fork of this invention.

FIG. 2 is a top view of the self-cleaning grilling fork of FIG. 1.

FIG. 3 is enlarged view perspective view of the self-cleaning tines of the grilling fork of FIG. 1.

FIG. 4 is section view of the grilling fork of FIG. 1, along section line AA.

FIG. 5 is sectional view of the grilling fork of FIG. 2, along section line BB.

### DESCRIPTION OF THE INVENTION INCLUDING PREFERRED EMBODIMENTS

In the Figures which accompany this description, a number of elements depicted therein are common to more than one Figure. Accordingly, for simplicity of expression and ease of understanding, an element in common to more that one Figure is assigned the same reference numeral in each Figure in which it appears.

FIG. 1 provides a side view of the preferred embodiment of the self-clearing grilling fork (10) of this invention. In this perspective, the fork (10) comprises a pistol grip handle (12), a hollow tubular shaft (14) and an array of tines (16, 16′). The ergonomic design of the pistol grip handle (12) incorporates both hand/finger contour features (18) and a trigger mechanism (20) for activation of a reciprocating clearing plate (22) associated with the tines (16, 16′) on the other end of the fork.

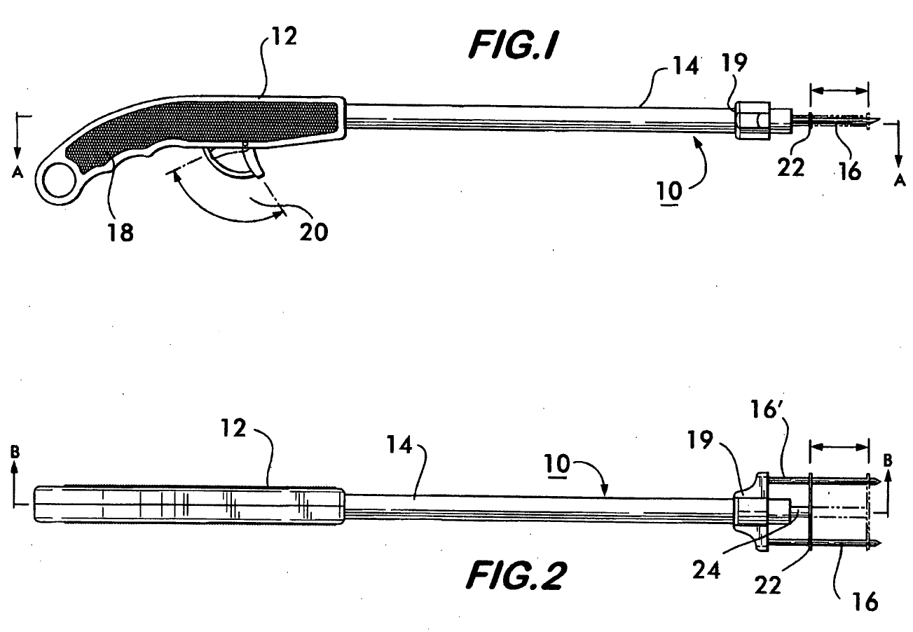

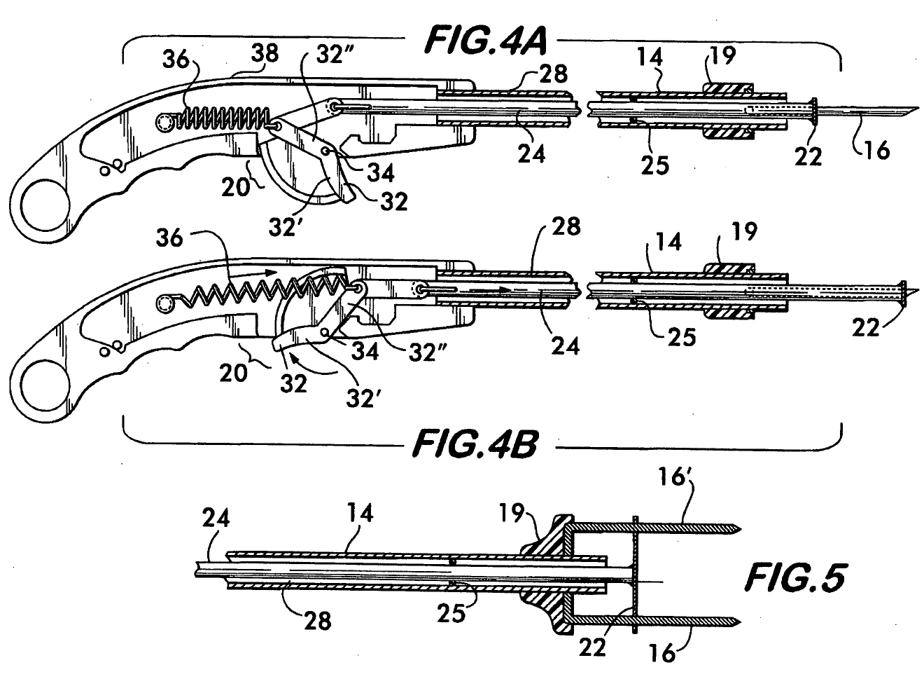

FIG. 2 provides a topside view of the self-clearing grilling fork (10) depicted in FIG. 1. In this perspective, the reciprocating clearing plate (22) is shown to have been advanced and retracted along the length of tines (16, 16′). The reciprocating movement of this reciprocating clearing plate (22) is caused by manual activation of the trigger mechanism (20) in the handle (12), which advances and retracts a sold shaft (24) connected to the back of the reciprocating clearing plate (22). This trigger mechanism (20) is more completely described in the discussion of FIGS. 4A & 4B.

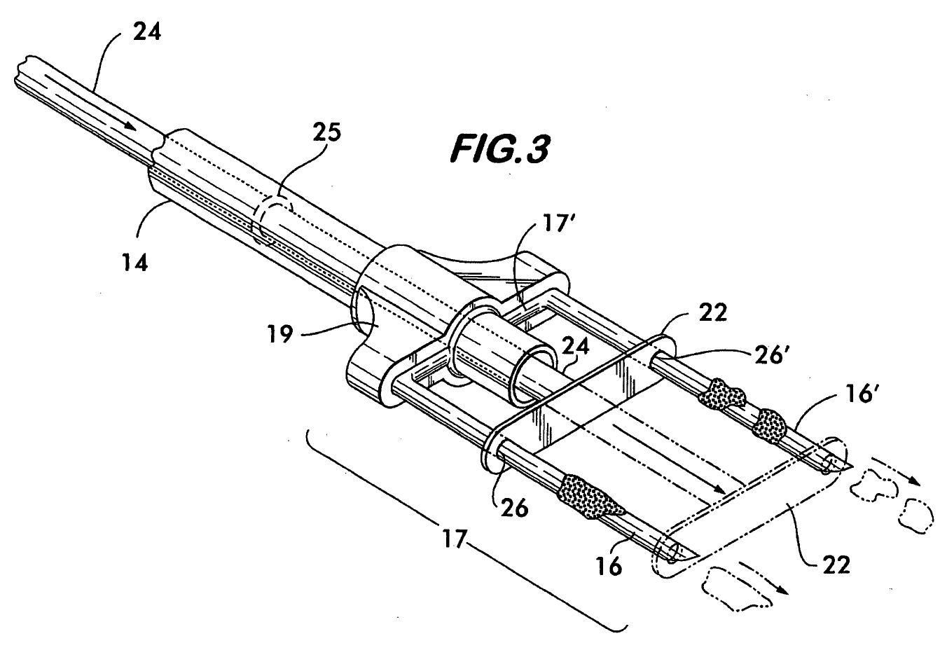

FIG. 3 provides an enlarged perspective view of the reciprocating clearing plate (22) associated with the tines (16, 16′) of the grilling fork illustrated in FIG. 2. More specifically, in this view the reciprocating clearing plate (22) is shown to have a series of apertures (26, 26′), which correspond in diameter and position to the tines (16. 16′) on the grilling fork. Thus, upon reciprocal movement of the reciprocating clearing plate (22) by the solid reciprocating shaft (24), the plate (22) is first advanced and then retracted, so as to displace any food and food residues from the surface of the tines (16, 16′). In order to preserve trouble free operation of the fork, a seal (26) is provided within channel (28) of the hollow tubular shaft (14). This seal, which preferably comprises a Teflon™ like material, conforms to the interior diameter of the hollow tubular shaft, and is fixedly mounted within the shaft in proximate relation to the tine assembly. This seal is further with hole of sufficient diameter to accommodate the movement of the solid reciprocating shaft relative to the hollow tubular shaft (14). This seal, in relation to both the hollow tubular shaft and the solid reciprocating shaft, prevents food residues, and other debris, associated with the cooking environment, from entering the channel (28) of the hollow tubular shaft (14). Accordingly, the reciprocating movement of the solid reciprocating shaft (24), relative to the hollow tubular shaft (14) remains substantially uninhibited.

FIG. 4 provides a cutaway view of the grilling fork (10) of FIG. 2 along plane AA. In each of the FIG. 4A and 4B, the internal workings (30) of the trigger mechanism (20) are depicted relative to the solid reciprocating shaft (24), and to the reciprocating clearing plate(22), associated with the tines (16, 16′) on the end of the fork. This trigger mechanism (20) includes a trigger (32), which is pivotally mounted to fixed attachment point (34) within the pistol grip handle (12). The trigger mechanism (20) comprises, in its simplest terms, a trigger (32); one portion of which extends from within the pistol grip (12) and is, thus, is exposed (32′), and an unexposed portion (32″), which remains within the pistol grip. The unexposed portion of the trigger (32″) is connected at the end thereof to a spring (36), and to articulating member (38), which in turn is connected to the solid reciprocating shaft (24).

As illustrated in FIG. 4B, the pulling of the exposed portion (32′) of the trigger (32) causes the unexposed portion thereof (32″) to pivot relative to the fixed attachment point (34), within the pistol grip handle (12), and thereby an extension of the spring (36) along with the forward movement of the solid reciprocating shaft (24). This forward movement of the shaft (24) also advances the reciprocating clearing plate (22) on the other end thereof, and thus the displacement of the food and food residues from the tines (16, 16′) of the fork. Conversely, upon release of the pulling pressure on the trigger (32), and the energy stored in the extended spring (36) pivots the trigger relative to its fixed attachment point (34), so as to cause the retraction of the reciprocating shaft (24) and the reciprocating clearing plate (22).

FIGS. 3 & 5 provide a perspective and sectional view, respectively, of the grilling fork of FIG. 1 at plane BB. In this perspective, (FIG. 3), the relationships of the hollow tubular shaft (14) and reciprocating solid shaft (24) are depicted relative to the tine assembly (16, 16′) of the fork. This tine assembly (17) of the fork is depicted as comprising a unitary assembly having a base (17′) and two projecting tines (16, 16′) extending forward from such base (17′). The base (17′) of this tine assembly (17) is fitted, or integrated into a yoke (19), or form fitted sleeve, that attaches to the hollow tubular shaft (14) of the fork. This yoke (19) provides for tortional stability of the tine assembly (17), and otherwise enhances it mechanical attachment to the hollow tubular shaft (14) of the fork.

As evident from the foregoing description of the preferred embodiments of this invention, the self-clearing grilling fork of this invention provides both simplicity of operation, and design enhancements that insure its trouble free operation.

The grilling fork of the present invention has been designed to be used with one hand, eliminating the necessity of removing food from the tines of the fork by means of the user's fingers, hands, or another utensil or tool, and allowing one of the user's hands to remain free. This fork, thus, provides the cook with a utensil which is easy to use with one hand, so as to insure a safe and controlled grilling environment.

1. In a grilling fork having a hollow shaft, a pistol grip handle on one end thereof, and an array of tines on other end thereof, wherein the improvement comprises:
A. An array of tines on one end of said grilling fork;
A. A hollow tubular hollow shaft, having a proximal end and a distal end, and an interior channel, of a uniform diameter, extending over the length of said shaft from said proximal end to said distal end of said grilling fork;
B. An elongate rod having a cross-sectional dimension of less than said diameter of said interior channel of said hollow tubular elongate shaft, and an overall length which (1) permits said rod to freely move within said channel of said shaft, and (2) to extend out from said proximal end of said hollow tubular shaft of said grilling fork,
C. Displacement means, operatively associated with the proximal end of said rod for dislodging food from said array of tines,
said displacement means including means for alignment of said displacement means relative to said array of tines, so as to maintain said displacement means in registration with said array of tine, upon relative movement thereof; and
D. Spring loaded means, housed within said pistol grip handle, and operatively associated with end of said rod extending from said proximal end of said hollow tubular shaft, for causing relative linear movement of said rod within said shaft, and thereby movement of said displacement means on
said distal end of said rod, so to dislodge food on said array of tines, said spring loaded means including a pivotally mounted trigger mechanically coupled to said rod and to a resilient spring, whereby application of pressure upon said lever causes forward movement of said lever, so as to both displace said rod within said shaft and extension of said spring, and release of pressure on said lever causes retraction of said rod and return of said spring to an unextended position.

2. The improved grilling fork of claim 1, further includes
E. a seal within said hollow tubular shaft, said seal having (1) a dimension essentially same as said interior channel of said tubular shaft, and fixedly attached proximate to said distal end of said shaft, and (2) an orifice corresponding in cross sectional area to said elongate rod,
so as to permit uninhibited reciprocating movement of said elongate rod, while at the same time preventing food residues from inhibiting said movement of said rod with said interior channel.

3. The improved grilling fork of claim 1, wherein the pistol grip handle is ergonomically shaped for user comfort, and comprises a textured surface for a more secure grip.

4. The improved grilling fork of claim 1, wherein said array of tines comprises at least two tines.

5. The improved grilling fork of claim 1, wherein said seal comprises a plurality of elements within said channel.
